(19) United States
(12) Patent Application Publication
(10) Pub. No.: US 2018/0018238 A1
(43) Pub. Date: Jan. 18, 2018

(54) SYSTEM AND APPARATUS FOR MANAGING FILES

(71) Applicant: FUJITSU LIMITED, Kawasaki-shi (JP)

(72) Inventors: Daisuke Tomii, Yokohama (JP); Ryoichi Asahi, Kawasaki (JP); Masaki Ikegame, Yokohama (JP); Tomoya Yamashita, Kawasaki (JP); Tetsuya KUSANO, Minato (JP)

(73) Assignee: FUJITSU LIMITED, Kawasaki-shi (JP)

(21) Appl. No.: 15/646,516

(22) Filed: Jul. 11, 2017

(30) Foreign Application Priority Data
Jul. 12, 2016 (JP) 2016-137399

(51) Int. Cl. G06F 11/14; G06F 17/30

(52) U.S. Cl. CPC G06F 11/1461; G06F 17/30091; G06F 11/1435; G06F 2201/84

(57) ABSTRACT

A file management apparatus accommodates removable storage media that store index data for use by a file system. The file management apparatus is used to read and write in these removable storage media. An information processing apparatus obtains and holds index data of each removable storage medium from the file management apparatus, and uses the index data to distinguish files recorded in the removable storage media. The file management apparatus determines the right time to make a backup of index data, based on a recovery time objective that specifies a duration of time for recovery from a system failure, and sends out a timing message indicating the determined right time. In response, the information processing apparatus causes the file management apparatus to make a backup in a specified removable storage medium.

### CROSS-REFERENCE TO RELATED APPLICATION

This application is based upon and claims the benefit of priority of the prior Japanese Patent Application No. 2016-137399, filed on Jul. 12, 2016, the entire contents of which are incorporated herein by reference.

### FIELD

The embodiments discussed herein relate to a file management system and a file management apparatus.

### BACKGROUND

Magnetic tape data storage is used to store digital data on magnetic tape media. For example, one proposed magnetic taps library device writes backup data of a host server to magnetic tape, while using some other storage device to record the index (specifically, creation date of backup), destination media information, and storage locations of backup data files. The proposed magnetic tape library device enables in a data restoration process a high-speed search operation for backup data by using the index.

Linear Tape File System (LTFS) is a file system used today for managing files on magnetic tape media. LTFS allocates a storage region of tape media to record index data for use by the file system, so that recorded data is treated as separate files. This storage region is called “index partition.”

For example, it has been proposed to reduce the frequency of updates of the index partition in an LTFS-based system. In usual unmounting of a tape cartridge in a tape library, the proposed method records its metadata not in the index partition, but in some other local storage, such as hard disk drives (HDD). The index partition of that tape cartridge is not updated until the cartridge is taken out of the library.

Another proposed technique is a device that has a first data storage medium and a second data storage medium. The first data storage medium is managed by a file system, and a backup copy of information about the file system is created in the second data storage medium.

See, for example, the following documents:

Japanese Laid-open Patent Publication No. 2014-67113

Japanese Laid-open Patent Publication No. 2015-90655

Japanese Laid-open Patent Publication No. 2014-182818

As discussed above, the index data of a file system may be recorded in a specific storage region of removable media (e.g., tape media). Such storage media are accommodated in a file management device (e.g., library apparatus) and maids available to other information processing devices (e.g., server computers). To make access to individual files recorded in storage media, an information processing device first obtains index data of each storage medium from the file management device. The information processing device holds a copy of this index data in its own local storage. With the copy of index data, the information processing device recognizes individual files and directory structure of a storage medium, without the need for directly reading index data stored in that storage medium.

Suppose now that an information processing device has lost its local copy of index data as a result of a failure. Here the system is supposed to recover from failure within a specific time called “recovery time objective.” One possible recovery solution may be to read index data from each and every storage medium and reconstruct a local copy of the index data for use in the information processing device. However, the file management device has only a limited number of drives for reading storage media and thus has to repeat loading and unloading operations at each drive. Reading index data in storage media is such a time-consuming task, and it therefore takes a long time for the information processing device to restore its lost copy of index data, possibly exceeding the recovery time objective noted above.

### SUMMARY

In one aspect, there is provided a file management system including: a file management apparatus that determines a right time to make a backup of index data, based on a recovery time objective that specifies a duration of time for recovery from a system failure, and sends out a timing message indicating the determined right time, the index data being for use by a file system to distinguish files recorded in removable storage media accommodated in the file management apparatus; and an information processing apparatus that obtains index data of each of the removable storage media from the file management apparatus, stores the obtained index data in a memory, and in response to the timing message from the file management apparatus, makes a backup of the index data stored in the memory, the backup being made in a specified removable storage medium accommodated in the file management apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates as file management system according to a first embodiment;

FIG. 2 illustrates an information processing system according to a second embodiment;

FIG. 3 illustrates an example of hardware configuration of a library;

FIG. 4 illustrates an example of hardware configuration of a server;

FIG. 5 illustrates an example of a tape medium;

FIG. 6 illustrates an example of how LTFS manages files;

FIG. 7 illustrates an example of partitions of tape media;

FIG. 8 illustrates an example of functions provided in an information processing system;

FIGS. 9A and 9B illustrate an example of update flags stored in a cartridge memory (CM);

FIG. 10 illustrates an example of an update management table;

FIG. 11 illustrates an example of a bitmap stored in CM of a specialized medium;

FIG. 12 is a flowchart illustrating an example of how the library determines the number of storage media to be read;

FIG. 13 is a flowchart illustrating an example of how the server updates data;

FIG. 14 is a flowchart illustrating an example of how the library manages tape media;

FIG. 15 is a flowchart illustrating an example of how the server backs up index data;

FIG. 16 is a flowchart illustrating an example of how the library loads a restoration medium;

FIG. 17 is a flowchart illustrating an example of how the server restores index data;

FIG. 18 illustrates an example of a sequence that updates data on tape media; and

FIG. 19 illustrates an example of a sequence that restores index data.

### DESCRIPTION OF EMBODIMENTS

Several embodiments will be described below with reference to the accompanying drawings.

### (a) First Embodiment

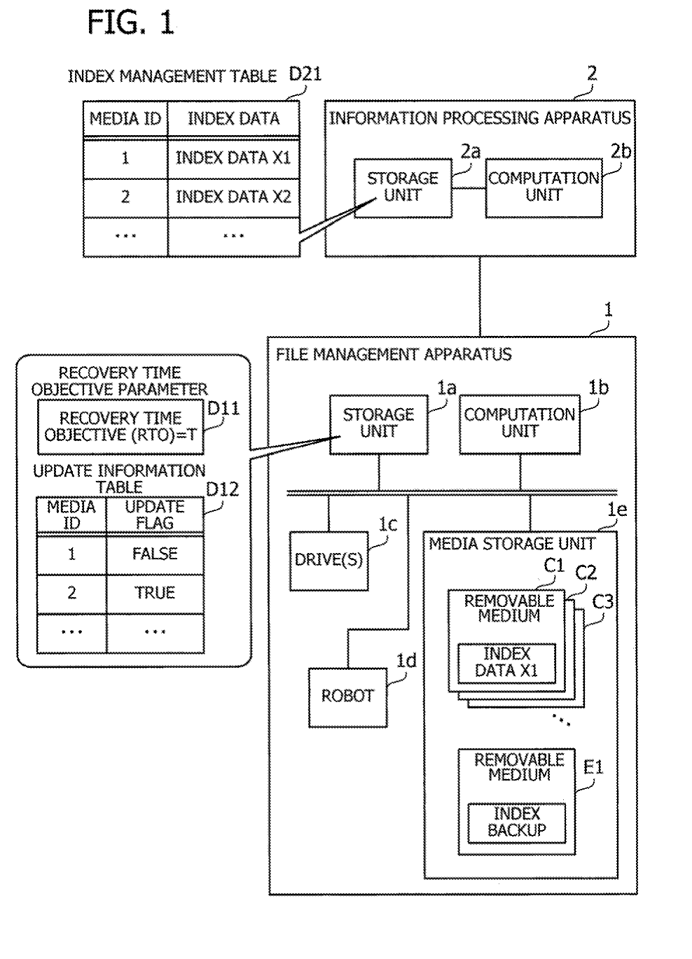

FIG. 1 illustrates a file management system according to a first embodiment. This file management system includes a file management apparatus 1 and an information processing apparatus 2.

The file management apparatus 1 accommodates a number of removable storage media (or simply, removable media), including tape media such as those based on the linear Tape-Open (LTO, registered trademark) technology. Other possible removable media include optical disc cartridges, such as Blu-ray (registered trademark) discs.

Each removable medium has a space for storing index data of the file system being used. As mentioned above, the removable media may be tape media or optical disc cartridges. In the former case, the LTFS may be used as a file system for controlling how data is stored in those media. In the latter case, some other appropriate file system (e.g., vender-specific file system) may be used.

The file management apparatus 1 reads and writes data in removable media. The file management apparatus 1 may be what is called a “library apparatus” or simply a “library” for removable media.

The information processing apparatus 2 interacts with the file management apparatus 1 to obtain a copy of index data stored in each removable medium. The information processing apparatus 2 includes the functions of a file system (e.g., LTFS). The information processing apparatus 2 maintains the obtained index data and uses it to distinguish individual files stored in each removable medium.

Specifically, the file management apparatus 1 includes a storage unit 1a, a computation unit 1b, a drive 1c, a robot 1d, and a media storage unit 1e. The storage unit 1a may be a volatile memory device, such as random access memory (RAM), or may be a non-volatile memory device, such as HDD and flash memory. The storage unit 1a stores therein a recovery time objective parameter D11 and an update information table D12.

The recovery time objective parameter D11 specifies a targeted time duration for recovery from a system failure. This is thus called “Recovery Time Objective” (RTO). The RTO value was previously specified and has been stored in the storage unit 1a. For example, the recovery time objective parameter D11 is set to RTO=T in the example of FIG. 1. In the event of failure in the information processing apparatus 2, it could disrupt the use of index data stored in the information processing apparatus 2. In this context, the RTO defines the maximum allowable time before recovery of the lost index data.

The update information table D12 is a collection of records indicating whether there has been any update to index data in each removable medium accommodated in the file management apparatus 1. For example, the update information table D12 is formed from data fields representing media identifier (media ID) and update flag. The media ID field of each record contains an identifier that distinguishes a specific removable medium from others. Cell IDs of removable media, indicating their cellular locations within the media storage unit 1e, may also serve the purpose. The update flag is a one-bit data structure that indicates whether any update has been made by the information processing apparatus 2 to index data since its previous backup. More specifically, update flag=“FALSE” denotes the absence of such updates. Update flag=“TRUE” means the presence of an update. Referring to the update information table D12 seen in FIG. 1, media ID “1” is associated with an update flag of “FALSE,” while media ID “2” is associated with an update flag of “TRUE.” Although not explicitly seen, the update information table D12 also holds other combinations of a media ID and an update flag.

The computation unit 1b may be a central processing unit (CPU), digital signal processor (DSP), application-specific integrated circuit (ASIC), field-programmable gate array (FPGA), or other processor circuitry. The computation unit 1b may be a processor configured to execute software programs. Here the term “processor” is used to refer to a single processing device or a multiprocessor system including two or more processing devices.

The computation unit 1b determines the right time for the information processing apparatus 2 to make a backup of its index data, based on a recovery time objective specified for recovery from a system failure. The computation unit 1b also updates update flags in the update information table D12.

The drive 1c is a device for reading and writing data in removable media. The file management apparatus 1 may be equipped with two or more such drives 1c. The robot 1d is a mechanism for transporting a removable medium from the media storage unit 1e to the drive 1c or from the drive 1c back to the media storage unit 1e.

The media storage unit 1e is a storage rack that accommodates a number of removable media. For example, the media storage unit 1e is capable of holding removable media C1, C2, C3, and so on, each containing files and their associated index data. The index data is used to distinguish each file from others. For example, one removable medium C1 has its index data X1, and another removable medium C2 has its index data X2. Likewise, other removable media also have index data of their own. The media storage unit 1e further accommodates a removable medium E1, which is specialized for storing a backup of index data that the information processing apparatus 2 makes. This backup may be referred to as an “index backup.” Although not explicitly indicated in FIG. 1, the removable media C1 and C2 are identified by their respective media IDs of “1” and “2.” Similarly, other removable media have their own distinguishable media IDs.

The information processing apparatus 2 includes a storage unit 2a and a computation unit 2b. The storage unit 2a may be a volatile memory device (e.g., RAM) or may be a non-volatile memory device (e.g., HDD and flash memory), similar to the storage unit 1a discussed above. The storage unit 2a stores therein an index management table D21, which is a collection of index data each read out of a removable medium C1, C2, C3, and so on. For example, the index management table D21 is formed from data fields representing media ID and index data. The media ID field of each record contains an identifier that distinguishes a removable medium from others. As mentioned before, media IDs may be replaced with cell IDs of removable media, indicating their cellular locations within the media storage unit 1e. The index data field contains index data that has been read out of a removable medium. For example, the index management table D21 seen in FIG. 1 contains index data X1 associated with a media ID of “1” (i.e., removable medium C1). For example, the information processing apparatus 2 may retrieve index data from each removable medium C1, C2, C3, . . . in the file management apparatus 1 before the system is brought into operation. The information processing apparatus 2 then populates the index management table D21 with the retrieved index data. In other words, the computation unit 1b may be configured to read out index data from each removable medium C1, C2, C3, . . . using a drive 1c before the system is brought into operation, and send it to the information processing apparatus 2. Alternatively, the computation unit 1b may be configured to send index data of a removable medium to the information processing apparatus 2 when the medium is made available for use with a file system (e.g., LTFS).

The computation unit 2b may be a CPU, DSP, ASIC, FPGA, or other processing device, as in the foregoing computation unit 1b. The computation unit 2b may be a processor configured to execute programs. Here the term “processor” is used to refer to a single processing device or a multiprocessor system including two or more processing devices.

The computation unit 2b provides the functions of a file system (e.g., LTFS) by executing specific programs stored in the storage unit 2a. For example, the computation unit 2b distinguishes files stored in removable media C1, C2, C3, . . on the basis of index data registered in the index management table D21. More specifically, the index data X1 permits the computation unit 2b to recognize the structure of directories and the properties (e.g., file name, last update date, and size) of files stored in the removable medium C1. When making access to a specific file, the computation unit 2b requests the file management apparatus 1 to transport the removable medium C1 to a drive 1c. Then with reference to the index data X1, the computation unit 2b instructs the file management apparatus 1 to do specific operations on the file of interest. When a file is added, changed, or deleted in a removable medium, the computation unit 2b updates its index data stored in the removable medium, as well as its corresponding copy in the index management table D21 in the storage unit 2a.

The computation unit 2b makes a backup of the index management table D21 stored in the storage unit 2a when it is triggered by the file management apparatus 1. This backup is what has been noted above as an index backup.

As mentioned above, the computation unit 1b in the file management apparatus 1 determines when to make a backup of index data, based on the system's recovery time objective T. In the event of a failure in the information processing apparatus 2, a recovery process would be executed to restore index data by using the last backup of the same. The computation unit 1b adjusts the time for backup making, so as to ensure that the recovery process will finish reading index data from removable media within the recovery time objective T. More specifically, the following equation (1) gives a recovery time objective T, which depends upon the maximum allowable number (K) of removable media that are subject to restoration of index data in the information processing apparatus 2 in the event of failure.

T=(t×K)/D (1)

The constant t represents the duration of time for reading index data per unit (i.e., per removable medium), including transport of removable medium to a drive 1c using the robot 1d. The constant D represents the number of drives available in the file management apparatus 1. Equation (1) is now transformed into equation (2), which permits the computation unit 1b to calculate K from T.

K=(T/t)×D (2)

The computation unit 1b drops a decimal fraction, if any, of the right-hand side of equation (2), thus extracting the integer portion of K.

The resulting number K suggests how many removable media could be read within a limited recovery time. Suppose, for example, that the information processing apparatus 2 has lost its index data due to some failure, necessitating a recovery process to restore the lost index data by reading index data from removable media C1, C2, C3, . . . , and E1. If the number of removable media to be read does not exceed K, it means that the recovery process would be finished in the time T (recovery time objective).

Taking the above into consideration, the computation unit 1b determines that the information processing apparatus 2 is to make a backup of index data when the number of removable media C1, C2, C3 , . . , with updated index data reaches K−1. It is noted that the recovery process always includes reading an index backup out of the removable medium E1. That, is, the recovery process reads at most K removable media, always including E1.

As discussed previously, the computation unit 1b manages updates of index data in the removable media C1, C2, C3, . . . by using an update information table D12 in the storage unit 1a. Suppose, for example, that the information processing apparatus 2 has manipulated a file in a certain removable medium and its index data has accordingly been modified. In response, the computation unit 1b looks into the update information table D12 and sets a value of “TRUE” to the update flag associated with the media ID of the removable medium. The computation unit 1b then counts the number of TRUEs in the update flag field of the update information table D12. If the count is K−1, the computation unit 1b clears all update flags to “FALSE” and sends a timing message to the information processing apparatus 2 so as to trigger a backup operation.

In response to the above timing message, the computation unit 2b in the information processing apparatus 2 commands the file management apparatus 1 to transport the removable medium E1 to the drive 1c, so that a backup of the index management table D21 (i.e., index backup) will be created in the removable medium E1. When the backup operation is completed, the computation unit 2b notifies the file management apparatus 1 of the completion.

The information processing apparatus 2 may encounter a failure and consequently lose the functionality of its index management table D21 in the storage unit 2a. In this case, the computation unit 2b restores the lost index management table D21 in the same storage unit 2a or a spare storage device. Specifically, the computation unit 2b requests the file management apparatus 1 to retrieve an index backup saved in the removable medium E1.

In response to the request, the computation unit 1b in the file management apparatus 1 investigates the update information table D12 to determine which removable media to read out, other than the removable medium E1, so as to restore the lost index data. These removable media do not exceed K−1 in number. The computation unit 1b informs the information processing apparatus 2 of the determined removable media. Using the file management apparatus 1, the computation unit 2b sequentially reads index data from the removable media specified by the information processing apparatus 2, thus populating its own index management table D21 with recovered data. In some cases, the information processing apparatus 2 may find no removable medium to read, other than the removable medium E1. Then it means that the previous backup in the removable medium E1 is sufficient for the computation unit 2b to restore the latest index data.

The file management apparatus 1 determines an upper limit (K−1) of the number of removable media to be read for the purpose of restoring index data, on the basis of a given recovery time objective T in the way described above. The file management apparatus 1 counts the number of removable media whose index data has been modified since the last backup, and determines when to make a backup next time on the basis of comparison between the media count and upper limit K−1. Consequently, the information processing apparatus 2 has only to read a limited number (K) of removable media, including the removable medium E1, to restore the index management table D21. In other words, the information processing apparatus 2 may regain the lost content of the index management table D21 before expiration of recovery time objective T.

It may be supposed that the system is operated without index backups. That is, the information processing apparatus 2 has no backup copy of its index management table D21, and the recovery process reads index data out of all removable media C1, C2, C3, and so on. The actual process of reading index data involves transporting removable media to drives 1c using a robot 1d and loading their magnetic tape on the drives 1c to read data. Here the number of drives 1c is limited. For these reasons, it takes a long time to read index data of all removable media. Suppose, for example, that the file management apparatus 1 accommodates 700 removable media. In this case, the information processing apparatus 2 may need about two days to reconstruct its file system. The system would therefore violate the predetermined recovery time objective T in the event of failure. This problem of long recovery time becomes more serious as the removable media increase in number.

It may also be supposed that an index backup is made in a removable medium E1 each time the removable media C1, C2, C3, . . . experience an update to their index data. This method, however, may hamper the main services of the system because it causes backup operations too often, with frequent and long occupation of drives 1c.

In view of the above, the proposed file management apparatus 1 keeps track of the number of removable media whose index data has been updated since the previous backup, and makes another backup when the number of such removable media reaches an upper limit K−1 that is given by equation (2). This method enables the information processing apparatus 2 to finish restoration of its index management table D21 within a recovery time objective T in the event of failure, using a removable medium E1 and other media. The proposed method executes backup operations less frequently than the upon-update backup method discussed above and is less intrusive to the main services of the system. Since the index backup is created in a removable medium E1, it is possible to properly restore the file system using removable media in the file management apparatus 1, even if the information processing apparatus 2 is failed.

### (b) Second Embodiment

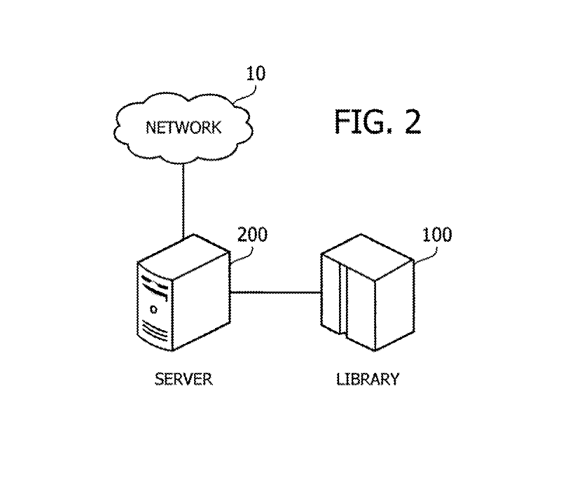

FIG. 2 illustrates an information processing system according to a second embodiment. This information processing system includes a library 100 and a server 200.

The library 100 accommodates a plurality of tape media as an example of removable media, and may thus be referred to as a tape library or a library apparatus. The library 100 is connected to a server 200 via a specific interface, such as Fibre Channel links. The library 100 is an example of the foregoing file management apparatus 1 of the first embodiment.

The server 200 is a server computer that provides services to support business-related activities. The server 200 is connected to a network 10, which may be a local area network (LAN) or a wide area network, such as the Internet. For example, the server 200 may provide the noted services to client computers (not illustrated) over the network 10. The server 200 is an example of the foregoing information processing apparatus 2 of the first embodiment.

The server 200 has the functions of LTFS to handle data stored in each tape medium in the library 100. The server 200 manipulates data in the form of files by, for example, adding files to, updating files in, and deleting files from tape media used, in its intended services.

The LTFS uses a specific part of a tape medium to store its index data. This part is called “index partition.” The index data in a taps medium indicates properties (attributes) of each file stored in the data partition of that medium, as well as directory structure of the data partition. For example, the properties of a file include its file name, size, creation date, and last modified date.

To read data out of a tape medium in the library 100, the tape medium is first transported from its storage ceil to a tape drive (simply referred to as a “drive”), and a read operation then takes place in the drive. Since this process is time-consuming, the server 200 has a cache for storing a copy of index data of individual tape media. The index data cache may be located in a non-volatile secondary storage device in the server 200 and used to manage the files stored in each tape medium. This caching mechanism eliminates the need for re-reading tape media upon rebooting of the server 200, thus permitting the server 200 to initiate file access in a short time.

However, the index data stored in the server 200 may be lost when its secondary storage device is failed. Some information processing systems, on the other hand, are supposed to satisfy a specific recovery time objective depending on the significance of their service. When the server 200 is part of such a system, the server 200 in the event of failure has to resume its service operations using LTFS within a recovery time objective, restoring its copy of index data. The library 100 thus provides the server 200 with control functions for making a backup of index data, such that the recovery time objective will be observed in case of failure.

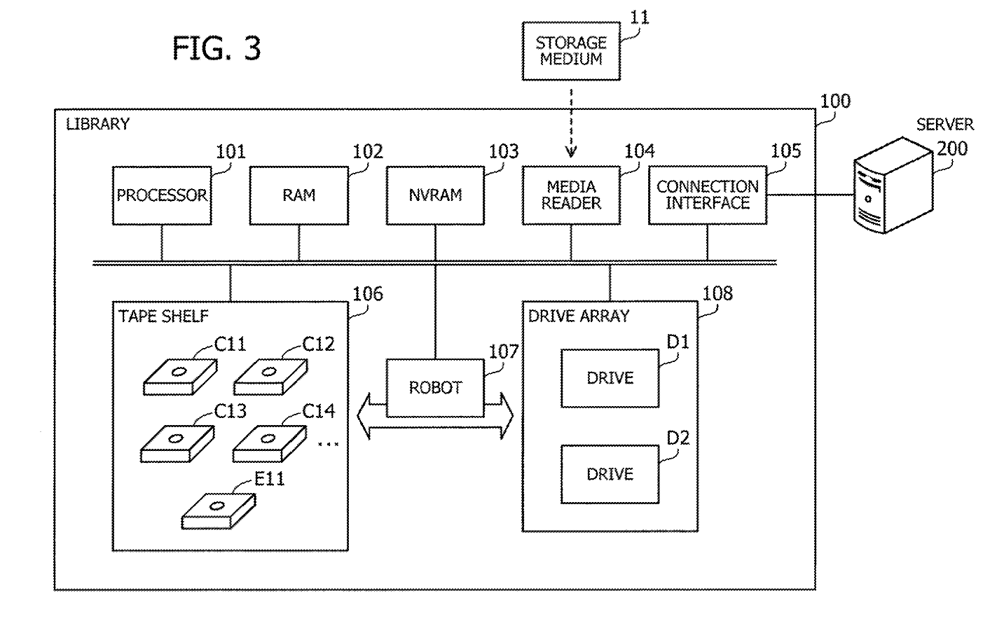

FIG. 3 illustrates an example of hardware configuration of a library. The illustrated library 100 includes a processor 101, a RAM 102, a non-volatile RAM (NVRAM) 103, a media reader 104, a connection interface 105, a tape shelf 106, a robot 107, and a drive array 108. All these components are connected to a bus in the library 100.

The processor 101 controls information processing operations in the library 100. The processor 101 may be a single processing device or a multiprocessor system including two or more processing devices. For example, the processor 101 may be a CPU, DSP, ASIC, FPGA, or any combination of these devices.

The RAM 102 serves as the primary storage device in the library 100. Specifically, the RAM 102 temporarily stores at least part of firmware programs and application programs that the processor 101 executes, as well as various data that the processor 101 uses in its processing operations.

The NVRAM 103 is a secondary storage device in the library 100. The NVRAM 103 electronically writes and reads data in its internal memory cells. Specifically, the NVRAM 103 stores firmware programs, application programs, and various data. The library 100 may include a flash memory as the NVRAM 103.

The media reader 104 is a device for reading programs and data stored in a storage medium 11, such as a flash memory card or other non-volatile semiconductor memory device. The media reader 104 transfers programs and data read out of a storage medium 11 to, for example, the RAM 102 or NVRAM 103 according to commands from the processor 101.

The connection interface 105 is a host interface for connection to a server 200. For example, Fibre Channel links may be used as the connection interface 105.

The tape shelf 106 is a storage rack that accommodates many tape media in multiple storage spaces, called “cells.” Each cell is able to hold one tape medium and has a distinguishable cell ID. That is, the cells have a one-to-one relationship with individual tape media placed in them. It is thus possible to distinguish each tape medium toy its corresponding cell ID.

A tape medium is composed of a reel of magnetic tape and a cartridge enclosing the magnetic tape. The magnetic tape is a narrow flexible strip on which a magnetic material is evaporated or coated. The cartridge is a housing case formed in a specific shape, designed to enclose the magnetic tape.

For example, the tape shelf 106 accommodates tape media C11, C12, C13, C14, and so on. The tape shelf 106 also accommodates a tape medium E11 for a particular purpose. These tape media conform to, for example, the LTO standard. The former tape media C11, C12, C13 , C14, . . . are used to record various files for service operations, whereas the latter tape medium E11 is dedicated for the purpose of backup of index data by the server 200. The rest of this description may refer to the above-noted tape medium E11 as a “specialized medium.” That is, the specialized medium E11 is used only for backup purposes.

The robot 107 transports a tape medium from the tape shelf 106 to a drive in the drive array 108 in response to a command from the processor 101. The robot 107 also transports a tape medium from a drive in the drive array 108 to the tape shelf 106 in response to a command from the processor 101.

The drive array 108 is a set of drives. The second embodiment assumes that two drives D1 and D2 are available in the drive array 108. The number of drives in the library 100 is, however, not limited by this specific example. For example, the library 100 may have only one drive or may have three or more drives. Both the drive D1 and drive D2 are tape drives used to write data to and read data from the tape media C11, C12, C13, C14, . . . and specialized medium E11 according to commands from the processor 101. The former drive D1 is capable of accommodating one tape medium and writing and reading data on its magnetic layer. Similarly, the latter drive D2 is capable of accommodating one tape medium and writing and reading data on its magnetic layer.

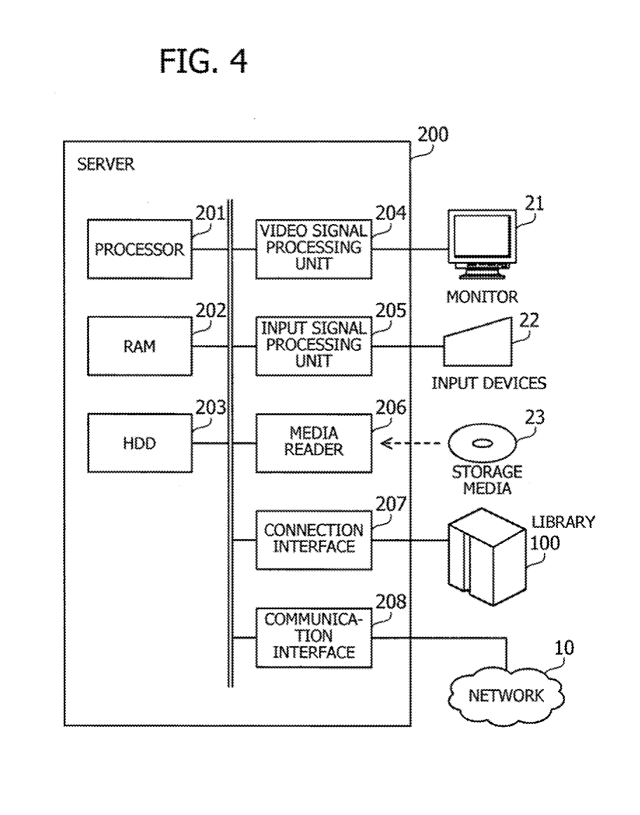

FIG. 4 illustrates an example of hardware configuration of a server. The illustrated server 200 includes a processor 201, a RAM 202, an HDD 203, a video signal processing unit 204, an input signal processing unit 205, a media reader 206, a connection interface 207, and a communication interface 208. All these components are connected to a bus in the server 200.

The processor 201 controls information processing operations that take place in the server 200. The processor 201 may be a single processing device or a multiprocessor system including two or more processing devices. For example, the processor 201 may be a CPU, DSP, ASIC, FPGA, or any combination of these devices.

The RAM 202 serves as the primary storage device in the server 200. Specifically, the RAM 202 temporarily stores at least part of operating system (OS) programs and application programs that the processor 201 executes, as well as various data that the processor 201 uses in its processing operations.

The HDD 203 is a secondary storage device in the server 200. The HDD 203 writes and reads data magnetically on its internal platters. Specifically, the HDD 203 stores OS programs, application programs, and various data. The server 200 may include one or more other secondary storage devices, such as flash memories and solid state drives (SSD) in place of, or together with the HDD 103.

The video signal processing unit 204 produces video images in accordance with commands from the processor 201 and outputs them on a screen of a monitor 21 coupled to the server 200. The monitor 21 may be, for example, a cathode ray tube (CRT) display or a liquid crystal display.

The input signal processing unit 205 receives input signals from input devices 22 coupled to the server 200 and supplies them to the processor 201. The input devices 22 include, for example, a keyboard and a pointing device such as a mouse and touchscreen.

The media reader 206 is a device used to read program files and data files stored in storage media 23. The storage media 23 include, for example, magnetic disk media such as HDD, optical disc media such as compact discs (CD), digital versatile discs (DVD), and Blu-ray discs, and magneto-optical storage media such as magneto-optical discs (MO). The storage media 23 also include non-volatile semiconductor memory devices such as flash memory cards. The media reader 206 transfers program files and data files read out of such a storage medium 23 to the RAM 202 or HDD 203, for example, according to commands from the processor 201.

The connection interface 207 is an interface device for connection to a library 100. For example, Fibre Channel links may be used to implement the connection interface 207.

The communication interface 208 is connected to a network 10, so that the processor 201 communicates with other apparatuses (not illustrated) via the network 10. The communication interface 208 may be designed for a wired network or a wireless network.

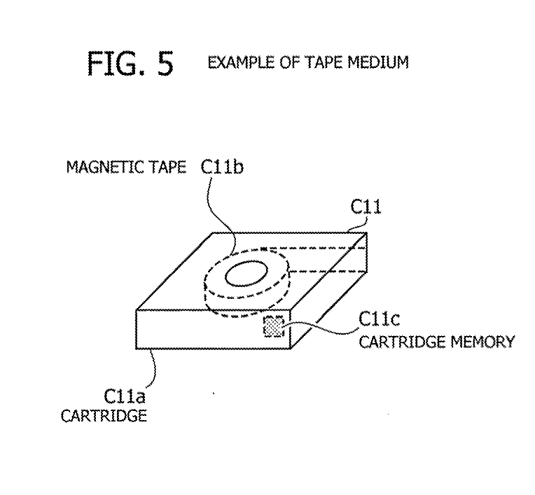

FIG. 5 illustrates an example of a tape medium. The illustrated tape medium C11 is formed from a cartridge C11a, a reel of magnetic tape C11b, and a cartridge memory C11c. As mentioned previously, the cartridge C11a serves as a housing case for the magnetic tape C11b. The magnetic tape C11b is where various data files are recorded for use in business-related processing operations. The cartridge memory C11c is an electrically-erasable programmable read-only memory (EEPROM) with a contactless interface. The library 100 uses this cartridge memory C11c to record management information relating to the tape medium C11. More specifically, drives D1 and D2 in the library 100 have a radio frequency (RF) interface to perform contactless communication with the cartridge memory C11c so that the processor 101 may write and read data therein, as well as erasing recorded data. Also the robot 107 has an RF interface for its contactless communication to achieve the same.

The fallowing description, and the accompanying drawings alike, may use the acronym “CM” to refer to the cartridge memory C11c. It is noted that other tape media C12, C13, C14, . . . and E11 are similarly formed from a cartridge, a reel of magnetic tape, and a cartridge memory.

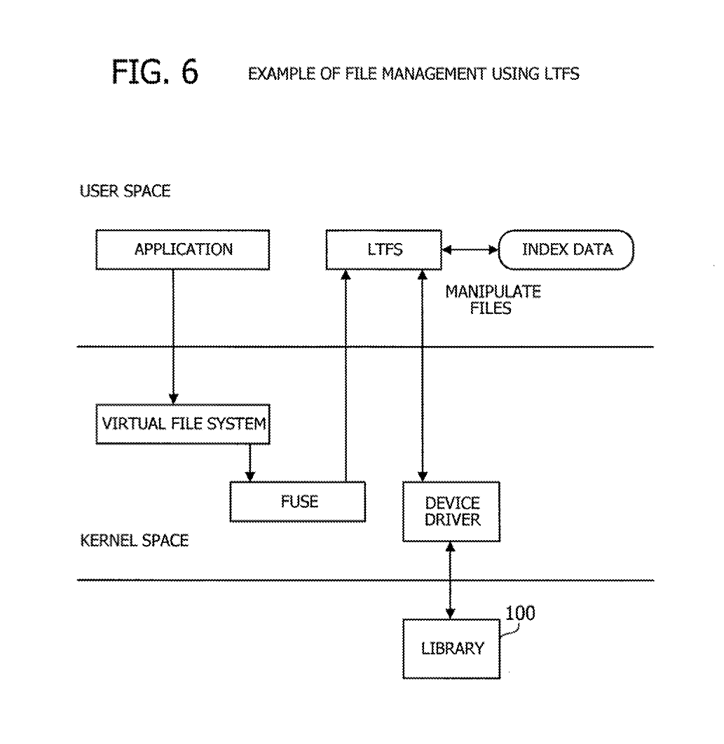

FIG. 6 illustrates an example of how LTFS manages files. For example, the LTFS is used through a particular software interface provided by the OS of the server 200. This interface is called “Filesystem in Userspace” (FUSE). For example, the server 200 executes virtual file systems, FUSE, and device drivers by using a kernel space of OS (i.e., address space of RAM 202 in which the OS kernel is running). The server 200 further executes business-related applications and LTFS by using a user space (i.e., address space of RAM 202 in which user software is running). The applications running in the user space are allowed to manipulate files by sending commands to the LTFS via a virtual file system and FUSE interface. When such a command is received, the LTFS searches index data held in the server 200 to identify which tape medium contains the file specified by the command. The LTFS then instructs the library 100 via a device driver to transport the identified tape medium to a specific drive and write or read the specified file.

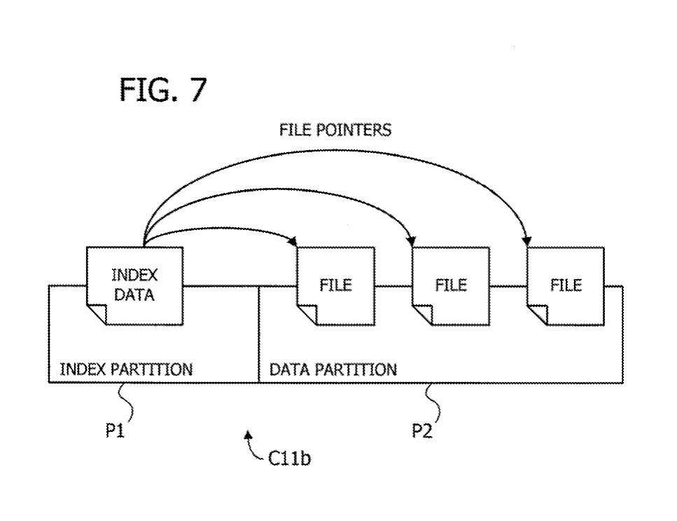

FIG. 7 illustrates an example of partitions of tape media. Specifically, FIG. 7 illustrates a magnetic tape C11b, whose storage space is divided into index partition P1 and data partition P2. The index partition P1 is a space for recording index data that describes what files are recorded, as well as where they are, in the data partition P2. As noted previously, this index data includes, among others, information about directory structure and file properties concerning the data partition P2. The index data further includes file pointers that indicate the storage locations (i.e., addresses) of individual files in the data partition P2.

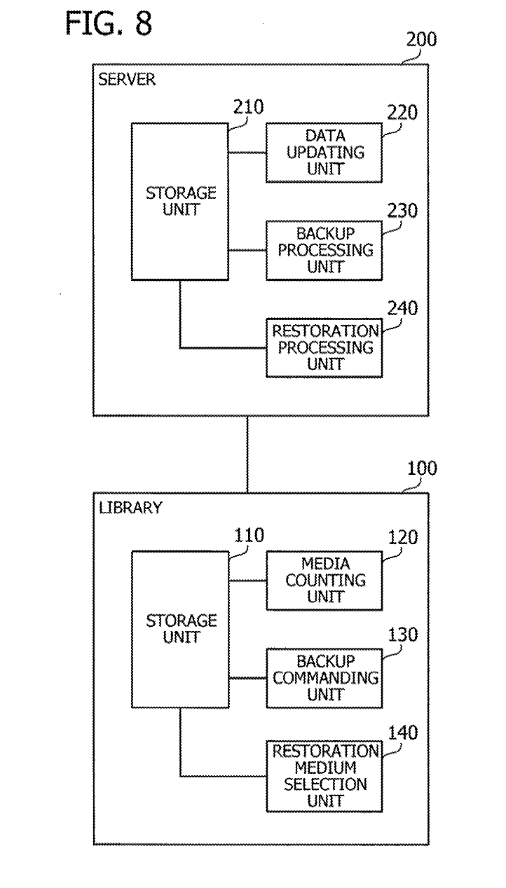

FIG. 8 illustrates an example of functions provided in an information processing system. The illustrated system includes a library 100 and a server 200. The library 100 includes a storage unit 110, a media counting unit 120, a backup commanding unit 130, and a restoration medium selection unit 140. The storage unit 110 in FIG. 8 is implemented as part of the storage space of the foregoing RAM 102 or NVRAM 103 in FIG. 3. The media counting unit 120, backup commanding unit 130, and restoration medium selection unit 140 in FIG. 8 are implemented as program modules, and the processor 101 provides their functions by executing these program modules on the RAM 102 in FIG. 3.

The storage unit 110 stores therein an update management table for management of updates made to index data of each tape medium. In addition, the storage unit 110 stores therein a parameter that indicates a recovery time objective, which denotes a desired length of time for restoration of lost index data in the server 200 in the event of a failure.

The media counting unit 120 determines the maximum number of tape media that the server 200 is allowed to read when restoring lost index data, and records the determined number in the storage unit 110. This number of tape media is referred to as “maximum read media count.” The media counting unit 120 determines a maximum read media count on the basis of the recovery time objective stored in the storage unit 110.

The backup commanding unit 130 determines when to make a backup of index data stored in the server 200, based on the maximum read media count that the media counting unit 120 has determined above. To this end, the backup commanding unit 130 manages the records of updates made to index data of tape media, by using the above-noted update management table in the storage unit 110. The backup commanding unit 130 notifies the server 200 of the determined backup time, so as to cause the server 200 to make a backup of its index data.

The restoration medium selection unit 140 specifies which tape media the server 200 is to read when it needs to restore index data. As will be described in a later section, the restoration medium selection unit 140 executes this operation on the basis of the update management table stored in the storage unit 110.

The server 200 includes a storage unit 210, a data updating unit 220, a backup processing unit 230, and a restoration processing unit 240. The storage unit 210 in FIG. 8 is implemented as part of the storage space of the HDD 203 in FIG. 4. The data updating unit 220, backup processing unit 230, and restoration processing unit 240 in FIG. 8 are implemented as program modules, and the processor 201 provides their functions by executing these program modules on the RAM 202 in FIG. 4.

The storage unit 210 stores therein a copy of index data of each tape medium, together with an ID of that medium. The ID of a tape medium may actually be an identifier used in a barcode attached to the cartridge of the tape medium, or may be a cell ID that indicates where in the tape shelf 106 the tape medium resides.

The data updating unit 220 obtains index data of individual tape media from the library 100 and stores it in the storage unit 210 together with corresponding tape media IDs. For example, the processor 101 in the library 100 may read and. send index data from each tape medium C11, C12, C13, C14, . . . using drives D1 and D2 to the server 200 before the system comes into service. Alternatively, the processor 101 may send index data of a tape medium to the server 200 when that tape medium is mounted for use with the LTFS. The data updating unit 220 receives such index data of tape media from the library 100 and stores it in the storage unit 210.

The data updating unit 220 may also command the library 100 to write and read files in the magnetic caps of each tape medium, as well as to write data and read in the cartridge memory of each tape medium. When a file is written in a tape medium, the data updating unit 220 updates its corresponding index data stored in the storage unit 210. The data updating unit 220 reflects the same update also in the index partition of the tape medium of interest.

The backup processing unit 230 makes a backup of each medium's index data stored in the storage unit 210 when so commanded from the library 100. This backup is created in a specialized medium E11, with the help of the library 100.

The restoration processing unit 240 is activated when the HDD 203 fails and the index data in the storage unit 210 is lost. Specifically, the restoration processing unit 240 restores the original index data in a spare HDD or other local storage in the server 200, so that the LTFS may resume its file management operation. More specifically, the restoration processing unit 240 reads index data from the specialized medium E11 and tape media that the library 100 specifies.

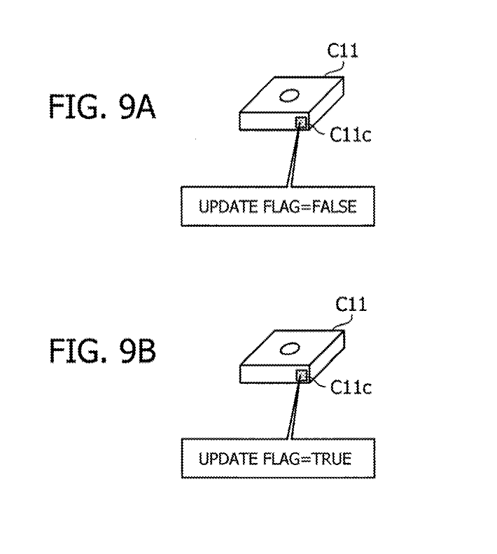

FIGS. 9A and 9B illustrate an example of update flags stored in a cartridge memory (CM). The tape medium C11 seen in FIGS. 9A and 9B uses its CM C11c to record an update flag. As seen in FIG. 9A, this update flag has a default value of “FALSE” to indicate that there is no change in index data of the tape medium C11. The data updating unit 220 sets a value of “TRUE” to the update flag when the index data is changed, as seen in FIG. 9B. The value “TRUE” denotes the presence of an update in the index data of the tape medium C11. Update flags in all tape media are initialized to “FALSE” when the server 200 begins to operate, as well as when a backup is made.

The backup commanding unit 130 reads out information in the CM C11c by using the robot 107 and modifies the update management table to record the current status of index data of the tape medium C11 as needed. Although FIGS. 9A and 9B illustrate one specific tape medium C11, other tape media similarly have an update flag in their respective CMs.

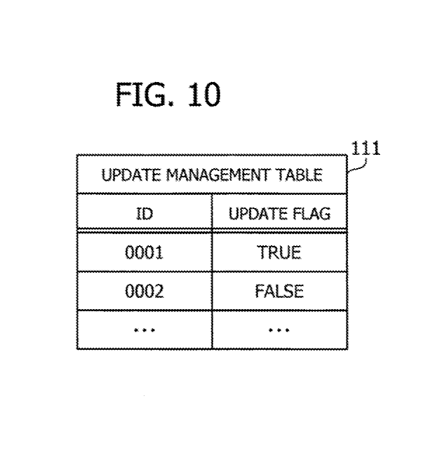

FIG. 10 illustrates an example of an update management table. This update management table 111 is formed from data fields representing ID and update flag and stored in the storage unit 110.

The ID field contains an ID for distinguishing tape media from each other. As mentioned before, the ID of a tape medium may be an identifier in a barcode attached to the cartridge of the tape medium, or may be a cell ID that indicates where in the tape shelf 106 the tape medium resides. The update flag field contains an update flag that indicates the presence (or absence) of updates in index data of the tape medium.

For example, the update management table 111 of FIG. 10 has an entry with ID=“0001” and Update Flag=“TRUE.” This entry means that the update flag of a tape medium C11 with an ID of “0001” has a value of “TRUE” (i.e., the index data has changed). The same update management table 111 also has an entry with ID=“0002” and Update Flag=“FALSE.” This entry means that the update flag of a tape medium C12 with an ID of “0002” has a value of “FALSE” (i.e., there is no change in index data).

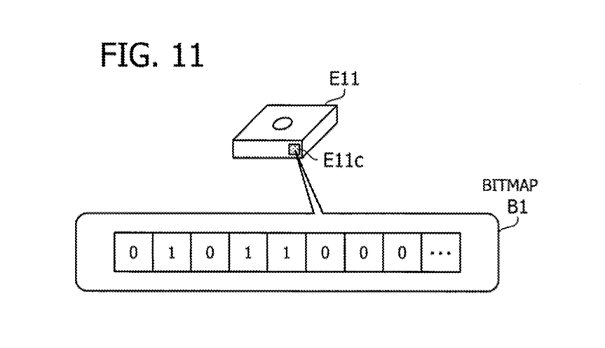

FIG. 11 illustrates an example of a bitmap stored in CM of a specialized medium. This specialized medium E11 has its own CM E11c. As a preparation for restoration of index data, the restoration medium selection unit 140 writes a bitmap B1 into the CM E11c. The bitmap B1 is an array data structure that indicates which tape media have to be read for the purpose of index data restoration in the server 200. The library 100 enters this bitmap B1 into a cartridge memory E11c in the specialized medium E11 when the server 200 executes a failure recovery process.

More specifically, the bitmap B1 is created from the update management table 111. The specialized medium E11 contains the latest backup of index data in each tape medium, while the bitmap B1 indicates whether the index data of each tape medium has been modified since the previous backup.

The bit positions in the bitmap B1 correspond one-to-one to the cell locations of tape media in the tape shelf 106. For example, the bitmap B1 is an array of at least 700 bits when the tape shelf 106 has 700 cells.

For example, one bit in the bitmap B1 may have a value of zero. In this case, the recovery process does not need to read the corresponding tape medium. Another bit in the bitmap B1 may have a value of one. This indicates that the recovery process is supposed to read the corresponding tape medium. The restoration processing unit 240 retrieves such a bitmap B1 from the specialized medium E11 via a drive D1 or D2, thus recognizing which tape media to read.

The next part of the description explains how the library 100 and server 200 specifically operate.

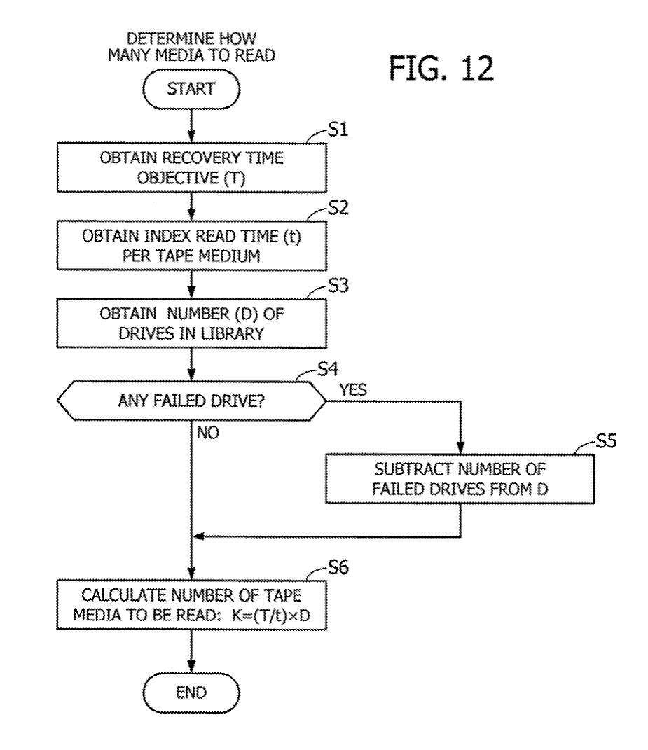

FIG. 12 is a flowchart illustrating an example of how the library determines the number of storage media to be read. Each operation in FIG. 12 is described below in the order of step numbers.

(S1) The media counting unit 120 obtains a recovery time objective T from the storage unit 110. Alternatively, the media counting unit 120 may receive a user input of recovery time objective T.

(S2) The media counting unit 120 obtains an index read time t per tape medium. This index read time t includes the time that the robot 107 consumes to transport a tape medium to a drive D1 (or D2). For example, the media counting unit 120 may conduct a measurement of index read time t using a certain tape medium. The media counting unit 120 may use the average of index read times measured with several tape media.

(S3) The media counting unit 120 obtains the number (D) of drives in the library 100. It is assumed that the library 100 has two drives (D=2) in the present example.

(S4) The media counting unit 120 determines whether the library 100 has any failed drive. If a failed drive(s) is found, the process advances to step S5. If no failed drive is found, the process skips to step S6.

(S5) The media counting unit 120 subtracts the number of failed drives from D. This operation removes inoperative drives from the current drive set.

(S6) The media counting unit 120 calculates the number (K) of tape media to be read, according to equation (2) discussed in the first embodiment. Specifically, the media counting unit 120 calculates K as in K=(T/t)×D. Here the media counting unit 120 drops a decimal fraction, if any, of the left-hand side, thus extracting the integer portion of K.

The above-noted equations (1) and (2) assume that the library 100 has only one robot. Some other libraries may, however, have two or more robots. In this case, the media counting unit 120 executes multiple read operations of index data in step S2, using multiple robots to handle N tape media (N is an integer greater than one). The media counting unit 120 measures the time consumed for the read operations from all N tape media and divides it by N, thus yielding an index read time t per tape medium in the case of multiple robots.

Equation (2), on the other hand, includes the number (D) of drives. It is therefore true to say that the media counting unit 120 calculates K (and K−1 alike) on the basis of the number of drives.

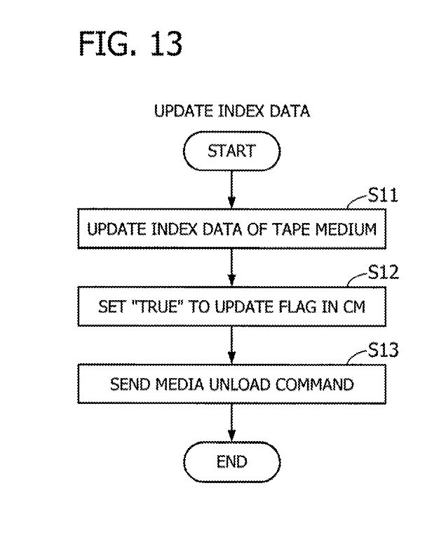

FIG. 13 is a flowchart illustrating an example of how the server updates index data. Each operation in FIG. 13 is described below in the order of step numbers, assuming that a tape medium C11 sits in a drive D1. It is also assumed that a certain file has been updated in data partition P2 of the tape medium C11.

(S11) The data updating unit 220 updates index data of the tape medium C11 of interest. Specifically, the data updating unit 220 updates index data stored in the storage unit 210, as well as index data recorded in the index partition of the tape medium C11 itself.

(S12) The data updating unit 220 sets a value of “TRUE” to the update flag in the cartridge memory C11c.

(S13) The data updating unit 220 sends a media unload command to the library 100 to unload the tape medium C11 from the drive D1.

It is noted that simply reading a file in the tape medium C11 makes no change in the file itself. In this case, the data updating unit 220 leaves the cartridge memory C11c intact since there is no need to change the update flag.

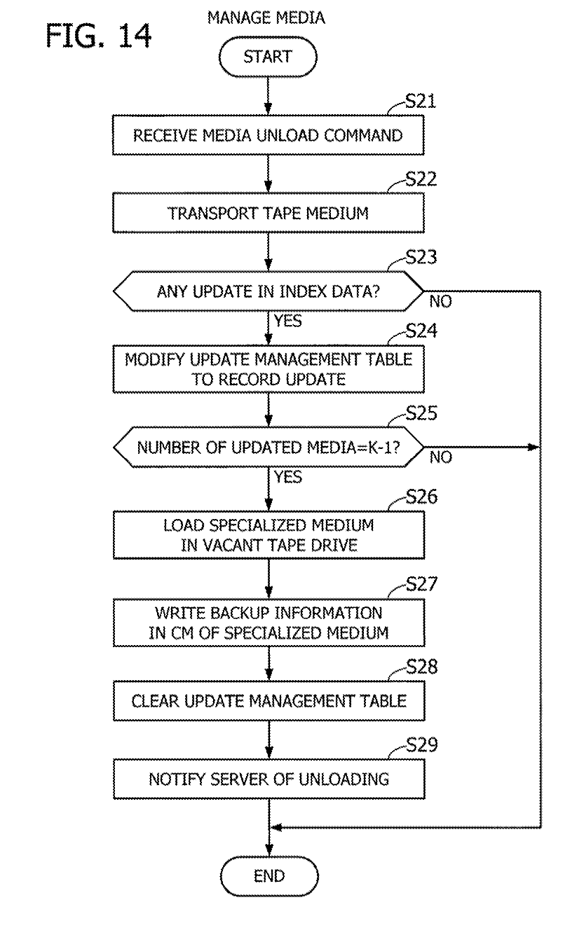

FIG. 14 is a flowchart illustrating an example of how the library manages tape media. Each operation in FIG. 14 is described below in the order of step numbers.

(S21) The backup commanding unit 130 receives a media unload command from the server 200. This command is what the data updating unit 220 has sent in step S13 of FIG. 13.

(S22) The backup commanding unit 130 causes the robot 107 to transport the tape medium C11 back to its home cell in the tape shelf 106. During this transport, the backup commanding unit 130 makes access to the cartridge memory C11c via the robot 107, thus reading its update flag.

(S23) The backup commanding unit 130 determines whether the update flag in the cartridge memory C11c indicates updated index data of the tape medium C11. When the update flag indicates updated index data (i.e., Update Flag=“TRUE”), the process advances to step S24. When there is no update (i.e., Update Flag=“FALSE”), the process is terminated.

(S24) The backup commanding unit 130 modifies the update management table 111 to record the update in index data of the tape medium C11. Specifically, the backup commanding unit 130 writes at value of “TRUE” along with an ID of “0001” as an update flag of the tape medium C11 in the update management table 111.

(S25) The backup commanding unit 130 determines whether the number of updated media has reached K−1. If it is K−1, the process advances to step S26. If it is smaller than K−1, then the present process is terminated. Here the term “updated media” denotes the tape media whose index data has experienced some change since the last backup (or since the media are put into operation). The number of updated media is obtained by counting records with an update flag of “TRUE” in the update management table 111.

(S26) The backup commanding unit 130 causes the robot 107 to load a specialized medium E11 in the drive that has been vacated (e.g., drive D1).

(S27) The backup commanding unit 130 causes the robot 107 to write backup information into the cartridge memory E11c of the specialized medium E11. The backup information actually indicates the content of the update management table 111. Specifically, the content of the update management table 111 permits the server 200 to recognize which tape media have experienced a change in their index data since the last backup. The server 200 may therefore make a differential backup relative to the last backup.

(S28) The backup commanding unit 130 clears the update management table 111. Specifically, the backup commanding unit 130 writes a value of “FALSE” to the update flag of each ID in the update management table 111.

(S29) The backup commanding unit 130 sends an unload completion notice to the server 200, thus notifying the server 200 that the media unload command of step S21 is completed.

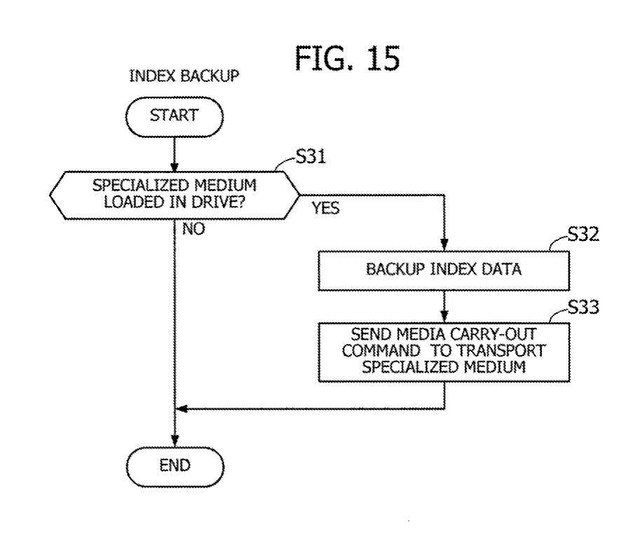

FIG. 15 is a flowchart illustrating an example of how the server backs up index data. Each operation in FIG. 15 is described below in the order of step numbers.

(S31) Upon receipt of an unload completion notice from the library 100, the backup processing unit 230 determines whether the drive D1 is holding a specialized medium. When a specialized medium is in the drive D1, the process advances to step S32. Otherwise, the process is terminated. For example, the determination of step S31 is made by reading a barcode attached to a tape medium, if any, in the drive D1 and checking whether the encoded identifier matches with the known identifier of the specialized medium E11.

(S32) The backup processing unit 230 backs up index data stored in the storage unit 210 by creating its copy in the specialized medium E11. Here the backup processing unit 230 has access to backup information in the cartridge memory E11c via the drive D1. This backup information indicates a difference in index data from the last backup, and the backup processing unit 230 has only to copy index data for this difference. However, the backup processing unit 230 is allowed to make a full backup of the index data stored in the storage unit 210 for all tape media.

(S33) The backup processing unit 230 sends a media carry-out command to the library 100 to transport the specialized medium E11.

Upon receipt of the media carry-out command of step S33, the library 100 causes the robot 107 to transport the specialized medium E11 from the drive D1 back to its home cell in the tape shelf 106. In this way, the server 200 backs up its local index data by making a copy in the specialized medium E11.

Referring to step S31 described above, the backup processing unit 230 checks whether a specialized medium E11 resides in the drive D1, in response to an unload completion notice from the library 100. In other words, the backup commanding unit 130 in the library 100 has implicitly triggered the server 200 to make a backup, by loading a specialized medium E11 to a drive D1. As an alternative, the backup commanding unit 130 may be configured to send an explicit instruction for backup in step S29 of FIG. 14, upon completion of unloading of a medium. This instruction may also indicate the fact that the specialized medium E11 is ready in a certain drive.

The following description explains a process of restoring index data of tape media from a backup stored in the specialized medium E11. This process is executed by the server 200 when its own copy of index data is lost due to a failure in the HDD 203 or the like. The server 200 restores index data in a replaced HDD or spare HDD that serves in place of the HDD 203.

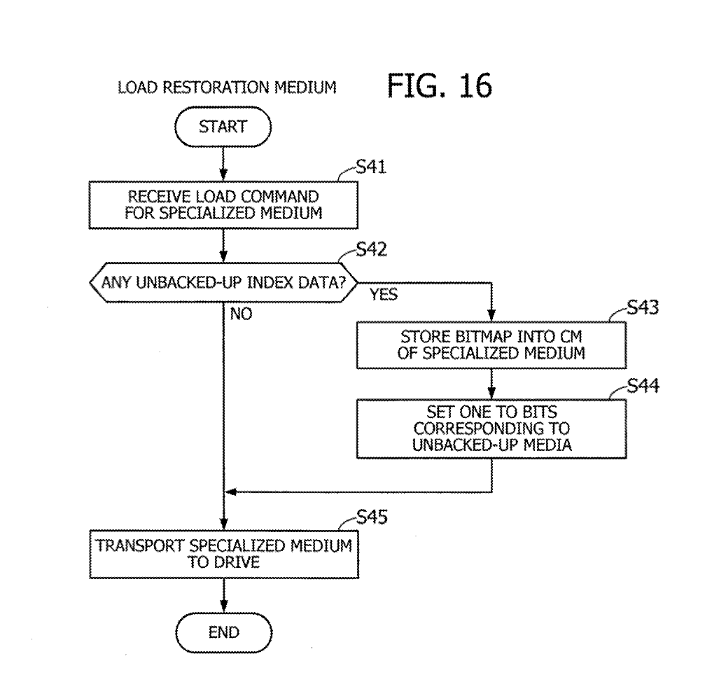

FIG. 16 is a flowchart illustrating an example of how the library loads a restoration medium. Each operation in FIG. 16 is described below in the order of step numbers.

(S41) The restoration medium selection unit 140 receives a load command for loading a specialized medium E11 from the server 200.

(S42) With reference to the update management table 111 in the storage unit 110, the restoration medium selection unit 140 determines whether there is any index data that has not been backed up. If any such “unbacked-up” index data is present, the process advances to step S43. Otherwise, the process skips to step S45. More specifically, the restoration medium selection unit 140 searches the update management table 111 for records having an update flag of “TRUE.” If such records are found, it affirms the presence of unbacked-up index data. If no such records are found, it negates the presence of unbacked-up index data.

(S43) The restoration medium selection unit 140 stores a bitmap B1 in the cartridge memory E11c of the specialized medium E11. This bitmap B1 has as many bits as the number of tape media in the tape shelf 106, each bit being given a default value of zero. Note that the specialized medium E11 may be excluded from the bitmap B1.

(S44) Some bits in the bitmap B1 correspond to unbacked-up tape media found in step S42. The restoration medium selection unit 140 gives a value of one to each of these bits in the bitmap B1. Specifically, the update management table 111 includes some IDs with an update flag of “TRUE,” and these IDs represent unbacked-up tape media.

(S45) The restoration medium selection unit 140 causes the specialized medium E11 to be transported to a drive specified in the load command. It is assumed in the present content that the drive D1 is specified as destination.

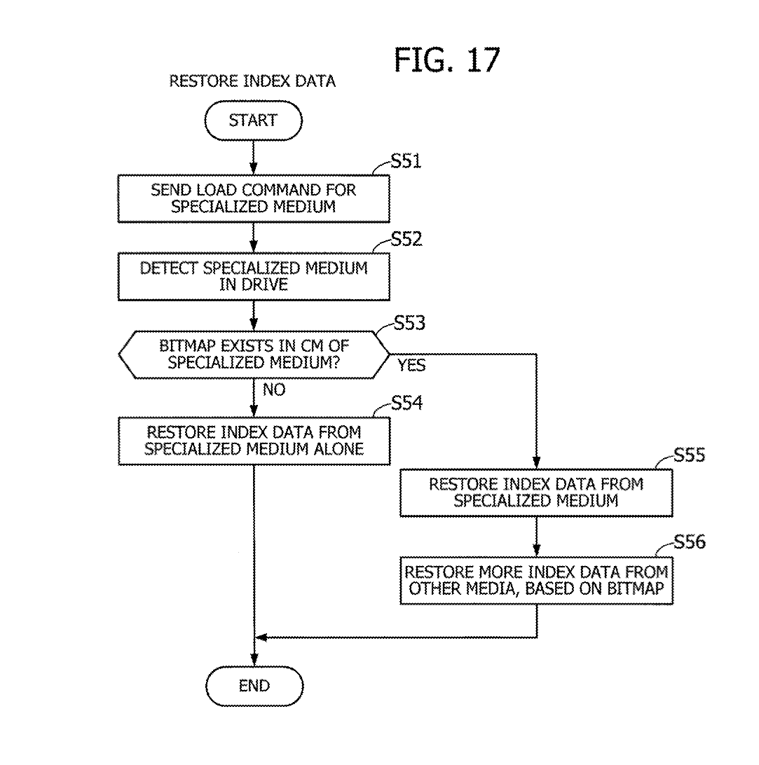

FIG. 17 is a flowchart illustrating an example of how the server restores index data. Each operation in FIG. 17 is described below in the order of step numbers.

(S51) The restoration processing unit 240 sends a load command to the library 100 to load a specialized medium E11. For example, transmission of a load command takes place after receipt of a user command for index data restoration via input devices 22. This step S51 corresponds to step S41 discussed above in FIG. 16. That is, the load command transmitted in step S51 and received in step S41 causes the library 100 to transport a specialized medium E11 to a drive D1.

(S52) The restoration processing unit 240 detects a specialized medium E11 loaded in the drive D1.

(S53) The restoration processing unit 240 determines whether the specialized medium E11 has a bitmap B1 in its cartridge memory (CM) E11c. When no bitmap B1 is found, the process advances to seep S54. When a bitmap B1 is found, the process branches to step S55.

(S54 ) The restoration processing unit 240 restores index data from the specialized medium E11. Specifically, the restoration processing unit 240 causes the library 100 to read index data out of the specialized medium E11 and restores the index data into a local storage device (e.g., a replaced HDD 203 or a spare HDD). The lack of a bitmap B1 means that no tape medium has unbacked-up index data, and the specialized medium E11 suffices for restoration of index data. The restoration processing unit 240 thus ends the restoration process, sending a media carry-out command to the library 100 to return the specialized medium E11 to its home cell.

(S55) The restoration processing unit 240 restores index data from the specialized medium E11. Specifically, the restoration processing unit 240 causes the library 100 to read index data out of the specialized medium E11 and stores the index data into a local storage device (e.g., a replaced HDD 203 or a spare HDD).

(S56) Based on the bitmap B1 in the cartridge memory E11c, the restoration processing unit 240 restores more index data from other tape media. The bitmap B1 indicates which tape media need to be read for the purpose of index data restoration. Specifically, the bits with a value of one in the bitmap B1 correspond to the cells that hold tape media to be read. The restoration processing unit 240 causes drives D1 and D2 to load these tape media one after another and read out index data of each loaded medium, thereby restoring the lost index data in the server 200. To manage the progress of index data restoration, the restoration processing unit 240 changes bit values in the bitmap B1 from one to zero, each time the index data of a tape medium is read and its restoration is finished. The restoration processing unit 240 may copy the bitmap B1 to the RAM 202 or HDD 203 for this purpose. When the restoration process is entirely finished, the restoration processing unit 240 sends a media unload command to the library 100 to unload the current tape media from the drives and exits from the process.

In connection with the procedures discussed above, the following description explains a specific example of communication sequence between the library 100 and server 200. The first sequence described below is to make a backup of index data after a file in a tape medium C11 is updated.

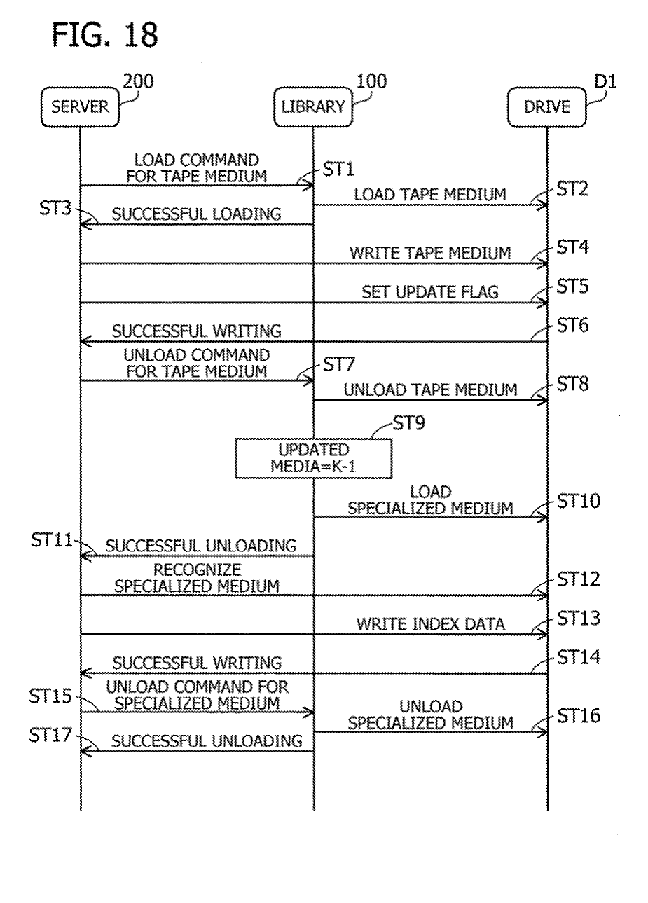

FIG. 18 illustrates an example of a sequence that updates data on tape media. Each operation in FIG. 18 is described below in the order of step numbers.

(ST1) The server 200 sends a load command to the library 100 to transport and load a tape medium C11 to a drive D1. The library 100 receives this load command.

(ST2) The library 100 executes the load command for the specified tape medium C11. Specifically, the library 100 causes its robot 107 to take the tape medium C11 out of the tape shelf 106 and transport it to a drive D1.

(ST3) The library 100 informs the server 200 of successful loading of the tape medium C11, and the server 200 receives this information.

(ST4) The server 200 writes data into the tape medium C11 loaded in the drive D1 of the library 100. Specifically, the server 200 adds a new file to, or changes or deletes an existing file in a data partition P2 of the tape medium C11. The server 200 also updates index data by modifying the index partition P1 of the tape medium C11. In addition, the server 200 updates index data in its own storage unit 210 to reflect the changes made to index data of the tape medium C11. In other words, the server 200 synchronizes its local index data with the tape medium C11.

(ST5) The server 200 writes an update flag of “TRUE” into a cartridge memory C11c of the tape medium C11 using the library 100.

(ST6) The drive D1 finishes its writing operation, and the library 100 detects that fact. The library 100 informs the server 200 of the successful writing, and the server 200 receives this information.

(ST7) The server 200 sends an unload command to the library 100 to unload the tape medium C11. The library 100 receives this unload command.

(ST8) The library 100 causes the robot 107 to unload the tape medium C11 from the drive D1 and transport it back to its home cell in the tape shelf 106. In this course, the library 100 makes access to a relevant update flag in the cartridge memory E11c via the robot 107 and records an update flag of “TRUE” in its update management table 111, thus marking the update in index data of the tape medium C11.

(ST9) The library 100 investigates the update management table 111 to count the number of updated media and compares the number with a threshold K−1. Suppose now that the library 100 finds that the number of updated media has reached K−1.

(ST10) The library 100 loads a specialized medium E11. Specifically, the library 100 causes its robot 107 to take the specialized medium E11 out of the tape shelf 106 and transport it to a drive D1. In this course, the library 100 writes the content of the update management table 111 in the storage unit 110 to a cartridge memory E11c of the specialized medium E11. Upon completion of this writing, the library 100 clears all update flags in the update management table 111 to “FALSE.” In other words, the library 100 resets the update management table 111.

(ST11) The library 100 informs the server 200 of successful unloading of the tape medium C11, and the server 200 receives this information.

(ST12) The server 200 recognizes that a specialized medium E11 is loaded in the drive D1.

(ST13) The server 200 causes the library 100 to read each medium's index data out of the storage unit 210 and write it in the specialized medium E11. As described above, step ST10 has written the content of the update management table 111 in the cartridge memory S11c. For example, based on what this cartridge memory E11c describes, the server 200 may determine which tape media need a backup (e.g., a differential backup relative to the last backup) of their index data.

(ST14) The library 100 detects that the drive D1 has finished writing index data. The library 100 then informs the server 200 of the successful writing of index data, and the server 200 receives this information.

(ST15) The server 200 sends an unload command to the library 100 to unload the specialized medium E11. The library 100 receives this unload command.

(ST16) The library 100 causes its robot 107 to unload the specialized medium E11 from the drive D1 and transport it back to its home cell in the tape shelf 106.

(ST17) The library 100 informs the server 200 of successful unloading of the specialized medium E11, and the server 200 receives this information.

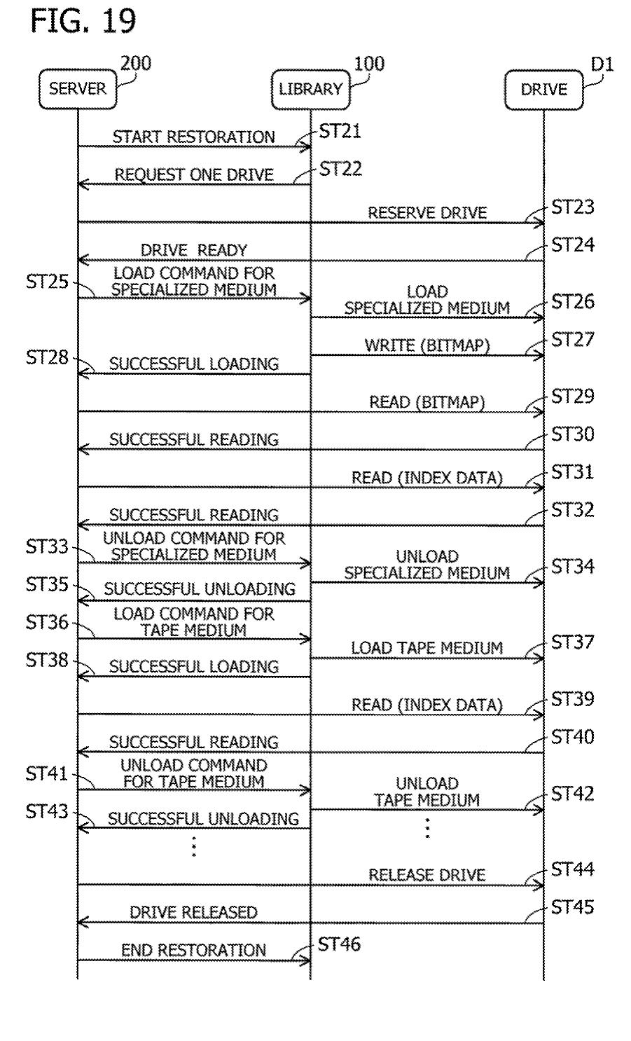

The next description explains a sequence of restoring index data in local storage of the server 200. FIG. 19 illustrates an example of a sequence that restores index data. Each operation in FIG. 19 is described below in the order of step numbers.

(ST21) The server 200 requests the library 100 to start restoration of index data. The library 100 receives this request.

(ST22) The library 100 requests reservation of one drive to the server 200. The server 200 receives this request.

(ST23) Upon receipt of the request for reservation of one drive, the server 200 commands the library 100 to reserve a drive. In response, the library 100 reserves a drive D1 for the purpose of index data restoration.

(ST24) The library 100 detects that a drive D1 is successfully reserved. The library 100 then informs the server 200 of successful reservation of a drive, and the server 200 receives this information.

(ST25) The server 200 sends a load command to the library 100 to transport and load a specialized medium E11 to the reserved drive D1. The library 100 receives this load command.

(ST26) The library 100 loads a specialized medium E11. Specifically, the library 100 causes its robot 107 to take the specialized medium E11 out of the tape shelf 106 and transport it to the drive D1.

(ST27) The library 100 writes a bitmap B1 into the cartridge memory E11c of the specialized medium E11. Initially, each bit of this bitmap B1 has a default value of zero. The library 100 sets a value of one to the bits corresponding to the tape media to be read for the purpose of index data restoration, according to the update management table 111 in the storage unit 110. The library 100 may execute this step ST27 before step ST26 or in parallel with step ST26.

(ST28) The library 100 informs the server 200 of successful loading of the specialized medium E11, and the server 200 receives this information.

(ST29) The server 200 causes the library 100 to read the bitmap B1 stored in the cartridge memory E11c of the specialized medium E11.

(ST30) The library 100 detects that the drive D 1 has finished reading of the bitmap B1. The library 100 then informs the server 200 of the successful reading, together with the bitmap B1 that is read, and the server 200 receives both of them.

(ST31) The server 200 causes the library 100 to read a backup of index data recorded on the magnetic tape of the specialized medium E11.

(ST32) The library 100 detects that the drive D1 has finished reading a backup of index data from the specialized medium E11. The library 100 then informs the server 200 of the successful reading, together with the backup of index data, and the server 200 receives both of them. The server 200 restores the received index data in its local storage.

(ST33) The server 200 sends an unload command to the library 100 to unload the specialized medium E11. The library 100 receives this unload command.

(ST34) The library 100 unloads the specialized medium E11. Specifically, the library 100 causes the robot 107 to unload the specialized medium E11 from the drive D1 and transport it back to its home cell in the tape shelf 106.

(ST35) The library 100 informs the server 200 of successful unloading of the specialized medium E11, and the server 200 receives this information.

(ST36) The server 200 determines which tape medium to read, based on the bitmap B1 read in steps ST29 and ST30. For example, the server 200 selects a tape medium C11 for reading and sends a load command for the tape medium C11 to the library 100, specifying the drive D1 as destination. The library 100 receives this load command.

(ST37) The library 100 loads the specified tape medium C11. Specifically, the library 100 causes its robot 107 to take the tape medium C11 out of the tape shelf 106 and transport it to the specified drive D1.

(ST38) The library 100 informs the server 200 of successful loading of the tape medium C11, and the server 200 receives this information.

(ST39) The server 200 causes the library 100 to read index data recorded on the index partition P1 of the tape medium C11.

(ST40) The library 100 detects that the reading of index data from the tape medium C11 is finished in the drive D1. The library 100 then informs the server 200 of the successful reading, together with the index data that is read. The server 200 receives both of them. The server 200 adds the received index data as a difference from the index data restored in step ST32.

(ST4) The server 200 sends an unload command for the tape medium C11 to the library 100. The library 100 receives this unload command.

(ST42) The library 100 unloads the tape medium C11. Specifically, the library 100 causes its robot 107 to unload the tape medium C11 from the drive D1 and transport it back to its home cell in the tape shelf 106.

(ST43) The library 100 informs the server 200 of successful unloading of the tape medium C11, and the server 200 receives this information.

Depending on the context, the restoration process may have to read two or more tape media. In this case, the library 100 and server 200 execute steps ST36 to ST43 as many times as the number of such tape media to be read. The library 100 and server 200 work together to read index data out of those tape media, using both drives D1 and D2 for the purpose of index data restoration.

(ST44) The server 200 commands the library 100 to release the reserved drive. The library 100 receives this command and releases the drive D1 accordingly.

(ST45) The library 100 detects that the drive D1 is successfully released. The library 100 then informs the server 200 of the successful release, and the server 200 receives this information. As noted above, the restoration process may occupy two or more drives. The server 200 then requests the library 100 to release each of those drives, and the library 100 releases the drives accordingly. The server 200 confirms the fact that all the reserved devices are released, before moving forward to step ST46.

(ST46) The server 200 sends a restoration end notice to the library 100, and the library 100 receives this notice.

The library 100 and server 200 make a backup of index data recorded on tape media in the way described above, so that the server 200 may restore its local index data when it is lost. As illustrated in FIG. 12, the library 100 determines how many tape media may be read to restore index data. This number K of tape media is determined on the basis of a specified recovery time objective T. The library 100 keeps track of the number of media that are updated since the last backup, and triggers another backup when the number of updated media reaches a threshold K−1. Consequently, the server 200 has only to read a limited number (K) of tape media, including the specialized medium E11, to restore its index data. In other words, the server 200 may regain the lost content of index data of each tape medium, back to the server's local storage, before expiration of the recovery time objective T.

It may be supposed that the system is operated without index backups. That is, the server 200 has no backup copy of its index data, and the recovery process has to read index data out of all tape media C11, C12, C13, and so on. The actual process of reading index data involves transporting tape media to drives D1 and D2 using a robot 107 and loading their magnetic tape on the drives D1 and D2 to read data. Here the number of drives D1 and D2 is limited. For these reasons, it takes a long time to read index data of all tape media. Suppose, for example, that the library 100 accommodates 700 tape media. In this case, the server 200 may need about two days to reconstruct its file system. The system would therefore violate the predetermined recovery time objective T in the event of failure. This problem of long recovery time becomes more serious as the tape media increase in number.

It may also be supposed that an index backup is made in a removable medium Si each time the tape media C11, C12, C13, . . . experience an update to their index data. This method, however, may hamper the main services of the system because it causes backup operations too often, with frequent and long occupation of drives D1 and D2.

In view of the above, the proposed library 100 keeps track of the number of tape media whose index data has been updated since the previous backup, and makes another backup when the number of such tape media reaches an upper limit K−1 that is given by equation (2). This method enables the server 200 to finish restoration of its index data within a recovery time objective T in the event of failure, using a specialized medium E11 and other media. The proposed method executes backup operations less frequently than the upon-update backup method discussed above and is less intrusive to the main services of the system.

Since the backup is created in a specialized medium E11, it is possible to properly restore the file system using removable media in the library 100, even if the server 200 is failed. As a variation of the second embodiment, the restoration of index data may be performed by some other server computer than the server 200. That is, some other server computer may reconstruct a file system by using a specialized medium E11 in the case of a failure in the server 200.

The foregoing data processing operations of the first embodiment may be implemented in the form of programs to be executed by the computation unit 1b. Similarly, the data processing operations of the second embodiment may be implemented in the form of programs to be executed by the processors 101 and 201. Those programs may be recorded on non-transitory computer-readable storage media 11 and 23. The library 100 may include a computer equipped with a processor 101 and a RAM 102. Likewise, the server 200 may include a computer equipped with a processor 201 and a RAM 202.

For example, the programs may be distributed using storage media 11 and 23. The programs may also be stored in a storage device of a computer for distribution to other computers via a network. For example, a computer (serving as a library 100) reads out programs from a storage medium 11 or receives programs from another computer and installs those programs into its local storage device (e.g., RAM 102 or NVRAM 103). Another computer (serving as a server 200) reads out programs from storage media 23 or receives programs from a remote computer and installs those programs into its local storage device (e.g., RAM 202 or HDD 203). Computers may execute programs read out of their local storage devices.

Several embodiments and their variations have been discussed above. In one aspect, the proposed techniques make it possible to restore index data within a recovery time objective.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A file management system comprising:
a file management apparatus that determines a right time to make a backup of index data, based on a recovery time objective that specifies a duration of time for recovery from a system failure, and sends out a timing message indicating the determined right time, the index data being for use by a file system to distinguish files recorded in removable storage media accommodated in the file management apparatus; and
an information processing apparatus that obtains index data of each of the removable storage media from the file management apparatus, stores the obtained index data in a memory, and in response to the timing message from the file management apparatus, makes a backup of the index data stored in the memory, the backup being made in a specified removable storage medium accommodated in the file management apparatus.

2. The file management system according to claim 1, wherein, in a failure recovery process of the information processing apparatus, the file management apparatus determines the right time to make a backup such that a total time consumption for reading index data from the removable storage media is shorter than or equal to the recovery time objective.

3. The file management system according to claim 1, wherein the file management apparatus calculates, based on the recovery time objective, an upper limit on a number of removable storage media to be read in a failure recovery process, and determines the right time to make a backup according to a comparison between the upper limit and a number of removable storage media whose index data have been updated since a last backup.

4. The file management system according to claim 3, wherein the file management apparatus calculates the upper limit, based on a number of drives that read and write data in the removable storage media.

5. The file management, system according to claim 4, wherein:
each time a removable storage medium is unloaded from one of the drives, the fixe management apparatus determines whether the unloaded removable storage medium has undergone an update to index data thereof; and
the file management apparatus sends the timing message to the information processing apparatus when the number of removable storage media whose index data have been updated reaches the upper limit.

6. The file management system according to claim 1, wherein:
the file management apparatus accumulates records each indicating occurrence of an update to index data of a removable storage medium after a last backup, and stores a copy of the records into a memory attached to the specified removable storage medium, when the information processing apparatus performs a failure recovery process; and
based on the copy of the records in the memory, the information processing apparatus selects removable storage media for reading index data, in addition to the specified removable storage medium.

7. A file management apparatus comprising:
a media storage unit that accommodates removable storage media each storing index data for use by a file system;
a drive that reads and writes data in a removable storage medium loaded therein; and
a processor configured to perform a procedure including:
reading the index data from each of the removable storage media by using the drive, and sending the index data to an information processing apparatus coupled to the file management apparatus,
determining a right time to make a backup of index data, based on a recovery time objective that specifies a duration of time for recovery from a system failure, and
sending a timing message to the information processing apparatus to indicate the determined right time.

8. A non-transitory computer-readable storage medium storing a program that causes a computer to perform a procedure comprises:
reading index data from removable storage media by using a drive, and sending the index data to an information processing apparatus, the index data being for use by a file system;
determining a right time for the information processing apparatus to make a backups of the index data, based on a recovery time objective that specifies a duration of time for recovery from a system failure; and
sending a timing message to the information processing apparatus to indicate the determined right time.
